(19) United States
(12) Patent Application Publication
(10) Pub. No.: US 2015/0029755 A1
(43) Pub. Date: Jan. 29, 2015

(54) LIGHT GUIDE PLATE AND METHOD FOR MANUFACTURING SAME

(71) Applicant: HON HAI PRECISION INDUSTRY CO., LTD., New Taipei (TW)

(72) Inventor: CHEN-HAN LIN, New Taipei (TW)

(21) Appl. No.: 14/334,254

(22) Filed: Jul. 17, 2014

(30) Foreign Application Priority Data
Jul. 24, 2013 (TW) 102126388

(51) Int. Cl. F21V 8/00; B32B 37/00

(52) U.S. Cl. CPC G02B 6/0016; G02B 6/0065; B32B 37/0046; B32B 2307/418
USPC 362/629; 156/242

(57) ABSTRACT

A light guide plate includes a first transparent base layer, an adhesive layer and a transparent composite layer. The adhesive layer is configured for bonding the transparent composite layer on the first transparent base layer. The transparent composite layer is located on the adhesive layer, and the transparent composite layer comprising a light emitting surface, the light emitting surface includes a plurality of microstructures.

### FIELD

The present disclosure relates to light guide plates, and methods for manufacturing the light guide plates.

### BACKGROUND

Large-sized liquid crystal displays have become popular because of a more realistic effect created. Thus, a large-sized light guide plate is also needed.

### BRIEF DESCRIPTION OF THE DRAWINGS

Implementations of the present technology will now be described, by way of example only, with reference to the attached figures, wherein:

FIG. 1 is an isometric view of a light guide plate in accordance with a first embodiment.

FIG. 2 shows an isometric view of a light guide plate in accordance with a second embodiment.

FIG. 3 shows an isometric view for manufacturing a transparent composite layer in FIG. 1.

FIG. 4 shows an isometric view of an imprint head used in FIG. 3.

FIG. 5 shows an isometric view of the transparent composite layer in FIG. 1.

FIG. 6 shows a state diagram during a manufacturing process of the light guide plate in FIG. 1.

FIG. 7 is a flow chart of a manufacturing method of the light guide plate in FIG. 1.

FIG. 8 shows an isometric view for manufacturing a transparent composite layer in FIG. 2.

FIG. 9 shows an isometric view of the transparent composite layer in FIG. 2.

FIG. 10 shows a state diagram during a manufacturing process of the light guide plate in FIG. 2.

FIG. 11 is a flow chart of a manufacturing method of the light guide plate in FIG. 2.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

The disclosure is described in relation to a light guide plate.

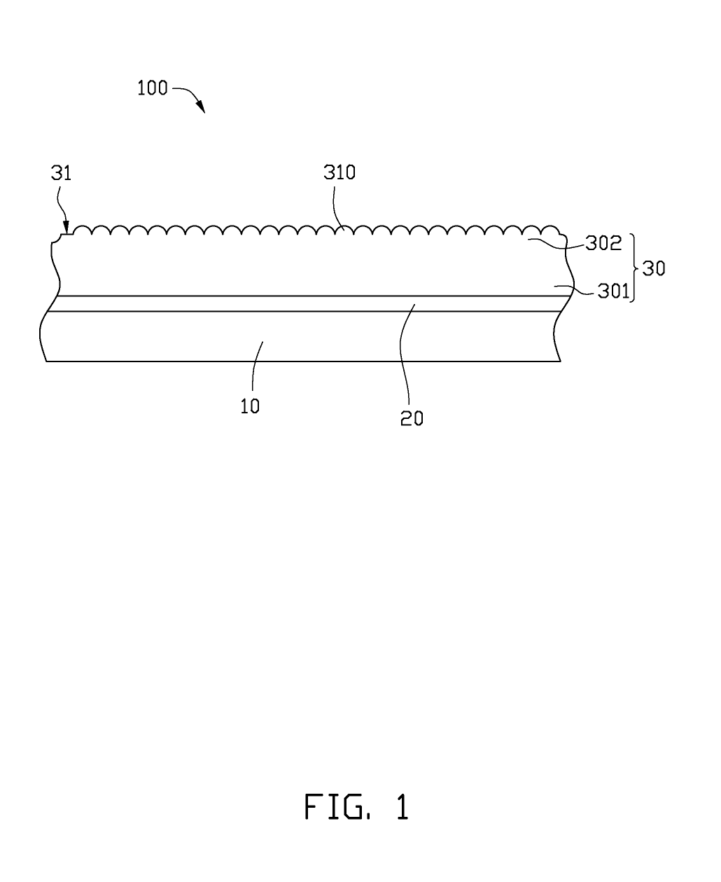

FIG. 1 shows a light guide plate 100 according to a first embodiment. The light guide plate 100 includes a first transparent base layer 10, an adhesive layer 20, and a transparent composite layer 30. The adhesive layer 20 is configured to bond the transparent composite layer 30 with the first transparent base layer 10.

The transparent composite layer 30 includes a light emitting surface 31 and is located on the adhesive layer 20. The light emitting surface 31 defines a number of V-shaped grooved microstructures 310. A thicknesses of both the first transparent base layer 10 and the transparent composite layer 30 are less than 100 microns, and a thickness of the adhesive layer 20 is less than 50 microns. The transparent composite layer 30 includes a second transparent base layer 301 and a microstructure layer 302 formed on the second transparent base layer 301. In at least one embodiment, a material of the second transparent base layer 301 is the same as a material of the microstructure layer 302.

In the illustrated embodiment, a refractive index of the transparent composite layer 30 is larger than a refractive index of the first transparent base layer 10. A refractive index of the adhesive layer 20 is between the refractive index of the first transparent base layer 10 and the refractive index of the transparent composite layer 30. In one embodiment, the first transparent base layer 10 is made of polymethylmethacrylate (PMMA). The transparent composite layer 30 is made of Polycarbonate (PC) or polyethylene terephthalate (PET). The adhesive layer 20 is made of a UV glue. That is to say, the refractive index increases gradually from the first transparent base layer 10 to the transparent composite layer 30, thus, as much light beam from a light source incident transmits into the light guide plate 100 and emits from the light emitting surface 31 as possible, and avoid from occurring total reflection, that is to say, relationships of the refractive index of the first transparent base layer 10, the adhesive layer 20, and the transparent composite layer 30 can reduce light beam from a light source emit from a bottom surface opposite to the light emitting surface 31 of the light guide plate, to improve the light emission rate.

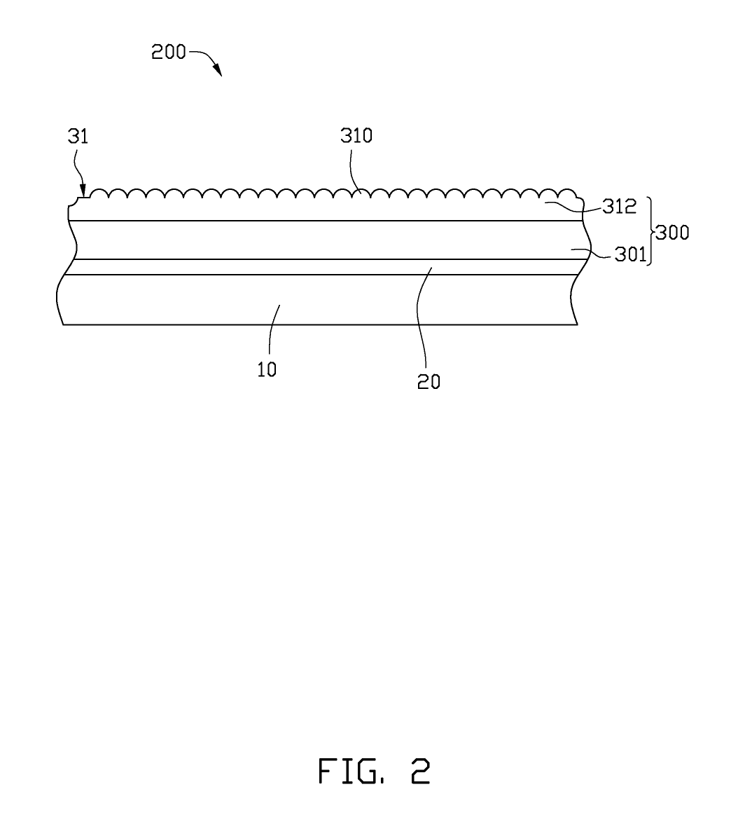

FIG. 2 illustrates a light guide plate 200 according to a second embodiment. The difference between the light guide plate 200 and the light guide plate 100 in the first embodiment is that the transparent composite layer 300 includes a second transparent base layer 301 and a microstructure layer 312. A material of the second transparent base layer 301 is different from a material of the microstructure layer 312. In the illustrated embodiment, the microstructure layer 312 is made of a UV glue.

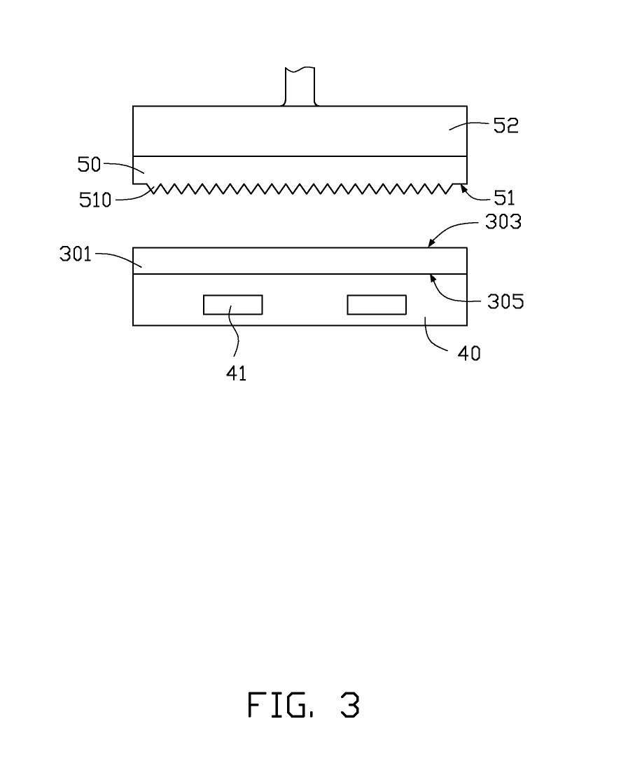

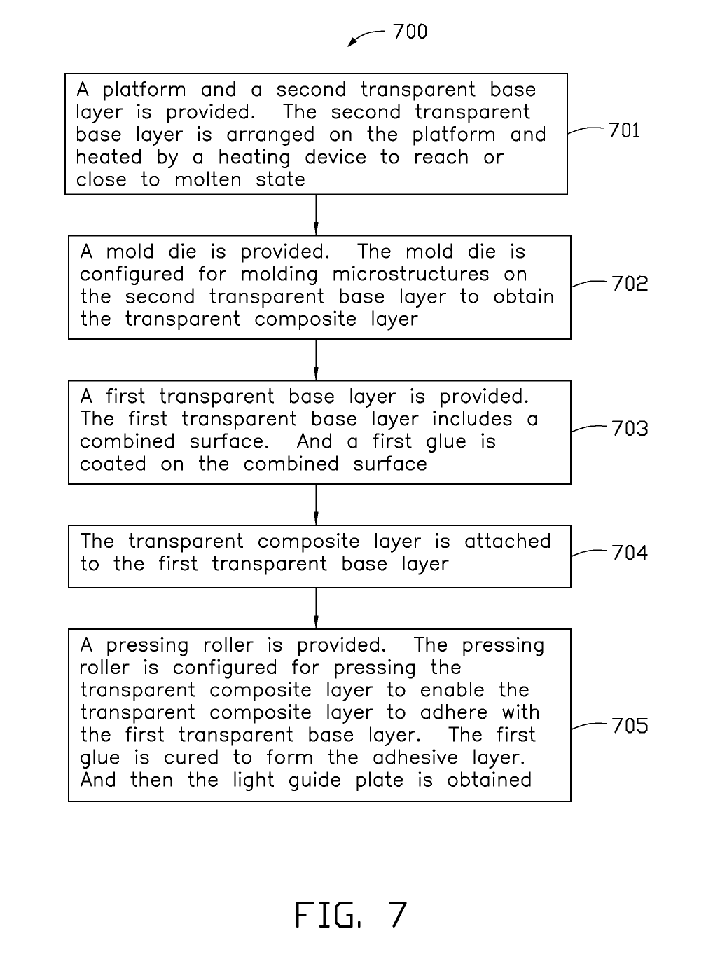

FIG. 7 is a flow chart of an exemplary method 700 for manufacturing the light guide plate 100. As shown in FIG. 7, the method of manufacturing the light guide plate may start from the block 701 and end at the block 705. And the exemplary manufacturing method 700 is describe below and can refer to FIGS. 3-6.

As shown in FIG. 3, a platform 40 and a second transparent base layer 301, as mentioned above, is provided. The second transparent base layer 301 is made of polycarbonate or polyethylene terephthalate. The platform 40 includes a heating device 41. The second transparent base layer 301 is arranged on the platform 40. The second transparent base layer 301 includes a first surface 303 and a second surface 305 away from the first surface 303. The second transparent base layer 301 is heated by the heating device 41 to reach or get close to a molten state.

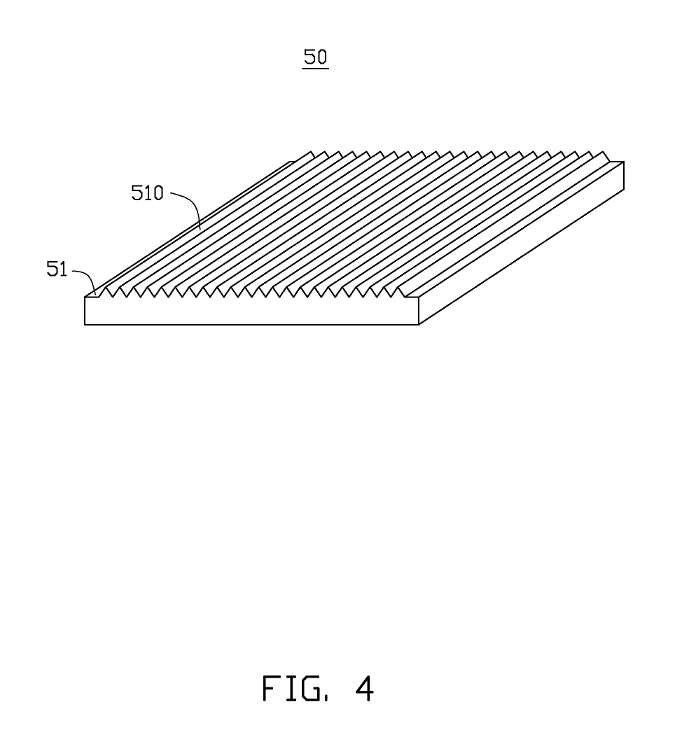

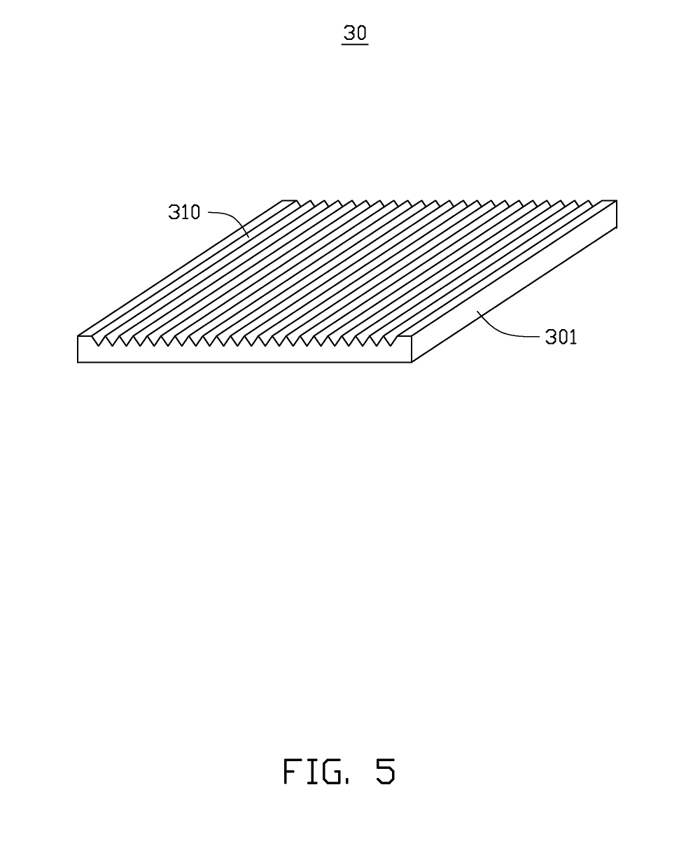

As shown in FIG. 4, a mold die 50 is provided, the mold die 50 is substantially cubic and comprises an pressing surface 51, the pressing surface 51 has a plurality of microstructures 510. A material of the mold die 50 is nickel or silicon. The mold die 51 is configured for molding microstructures 510 on the first surface 303 of the second transparent base layer 301 to obtain the transparent composite layer 30, as shown in FIG. 5. In one embodiment, the mold die 50 is fixed with an imprint head 52, as shown in FIG. 3. The imprint head 52 is fixed with a driving device (not shown), the driving device is used for driving the mold die 50 to move close, or away from the platform 40.

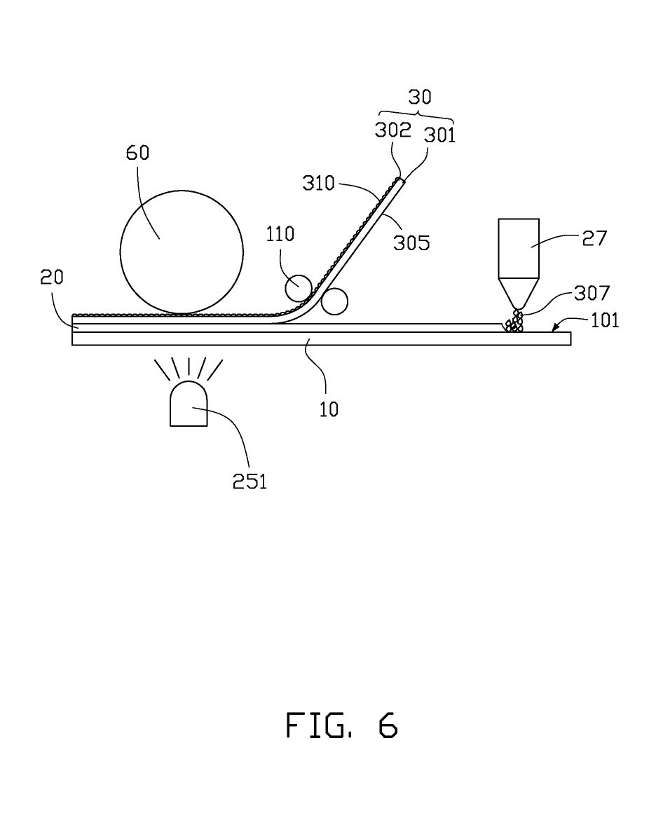

As shown in FIG. 6, a first transparent base layer 10 is provided. The first transparent base layer 10 includes a combined surface 101. In one embodiment, the first transparent base layer 10 is PMMA. And a first glue 307 is coated on the combined surface 101. In one embodiment, the first glue 307 is a UV glue and a coating device 27 applies the first glue 307. In the illustrated embodiment, a refractive index of the transparent composite layer 30 is larger than a refractive index of the first transparent base layer 10. A refractive index of the adhesive layer 20 is between a refractive index of the first transparent base layer 10 and a refractive index of the transparent composite layer 30.

As shown in FIG. 6, the transparent composite layer 30 is attached to the first transparent base layer 10. In one embodiment, the second surface 305 of the transparent composite layer 30 is attached with the first transparent base layer 10.

As shown in FIG. 6, a pressing roller 60 and a number of pressure wheels 110 are provided. A material of the pressing roller 60 can be, but is not limited to, rubber or foam. A material of the pressing roller 60 must not damage the microstructures 310 on the transparent composite layer 30. The pressing roller 60 is configured to press the transparent composite layer 30 to enable the transparent composite layer 30 to adhere to the first transparent base layer 10. The pressure wheels 110 are configured for tightening the transparent composite layer 30 and preventing the transparent composite layer 30 from crimping. The first glue 307 is cured to form the adhesive layer 20. In at least one embodiment, a UV curing device 251 is provided to cure the first glue 307. And then the light guide plate 100 (as shown in FIG. 1) is obtained.

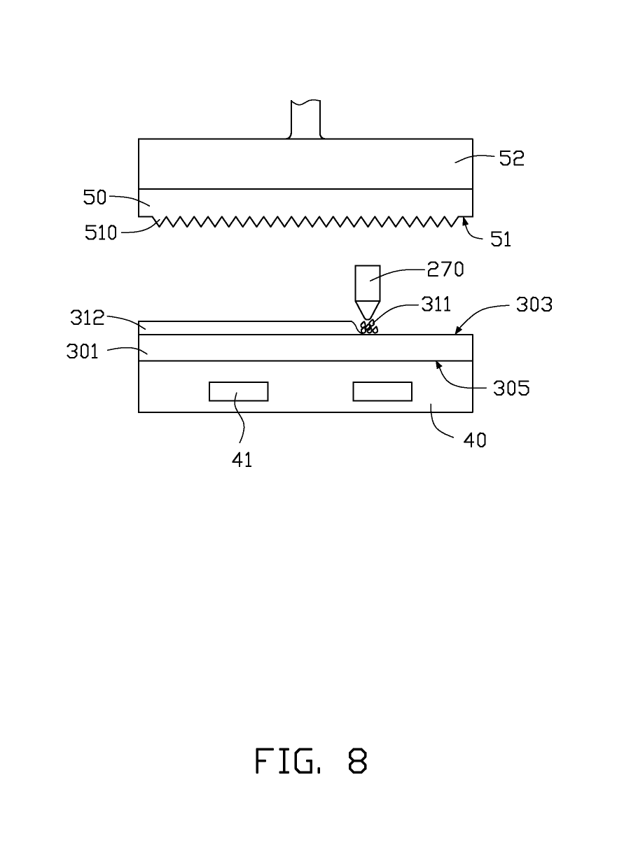

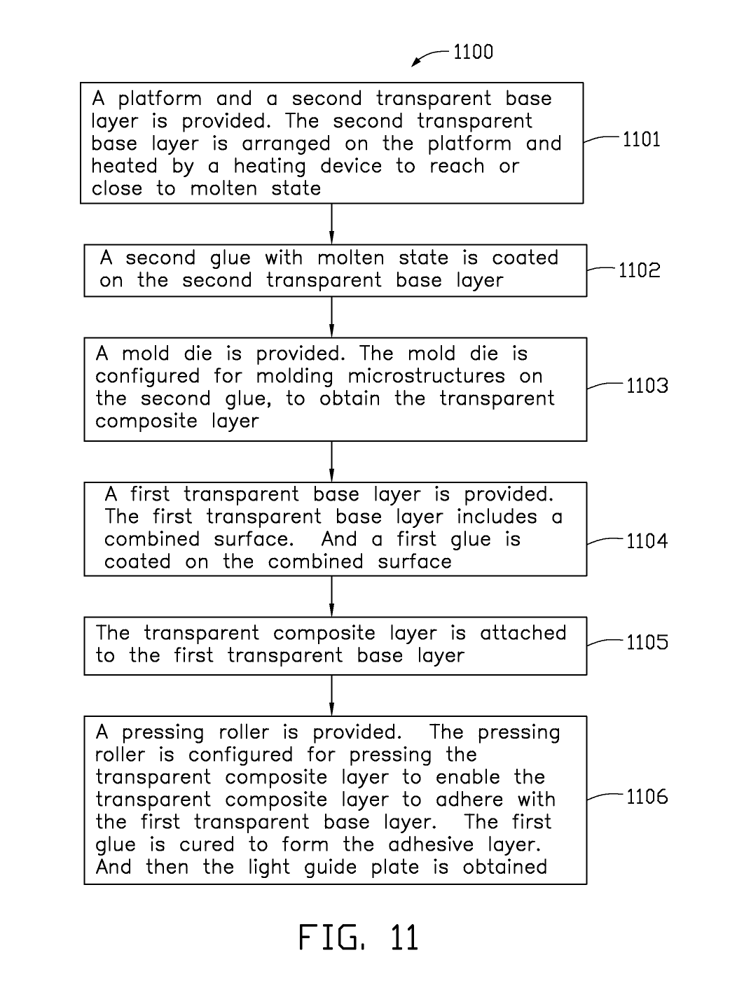

FIG. 11 is a flow chart of an exemplary method 1100 for manufacturing the light guide plate 200. As shown in FIG. 11, the method of manufacturing the light guide plate may start from the block 1101 and end at the block 1106. And the exemplary manufacturing method 1100 is describe below and can refer to FIGS. 8-10.

As shown in FIG. 8, a platform 40 and a second transparent base layer 301 is provided. The second transparent base layer 301 is made of PC or PET. The second transparent base layer 301 is arranged on the platform 40, and includes a first surface 303 and a second surface 305 away from the first surface 303.

As shown in FIG. 8, a second glue 311 with molten state is coated on the first surface 303. In one embodiment, the second glue 311 is a UV glue and the coating device 270 is applied for coating the second glue 311.

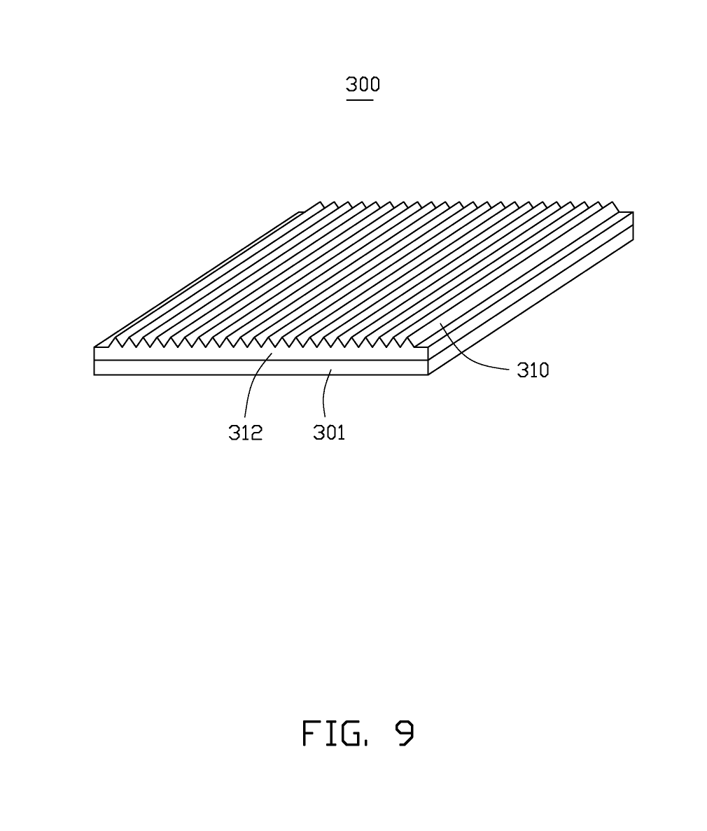

As shown in FIG. 8, a mold die 50 is provided, the mold die 50 is substantially cubic and comprises an pressing surface 51, the pressing surface 51 has a plurality of microstructures 510, the mold die 50 is configured to mold microstructures 510 on the second glue 311, the second glue 311 is used to form the microstructure layer 312, after curing of the second glue 311, the transparent composite layer 300 is obtained, as shown in FIG. 9.

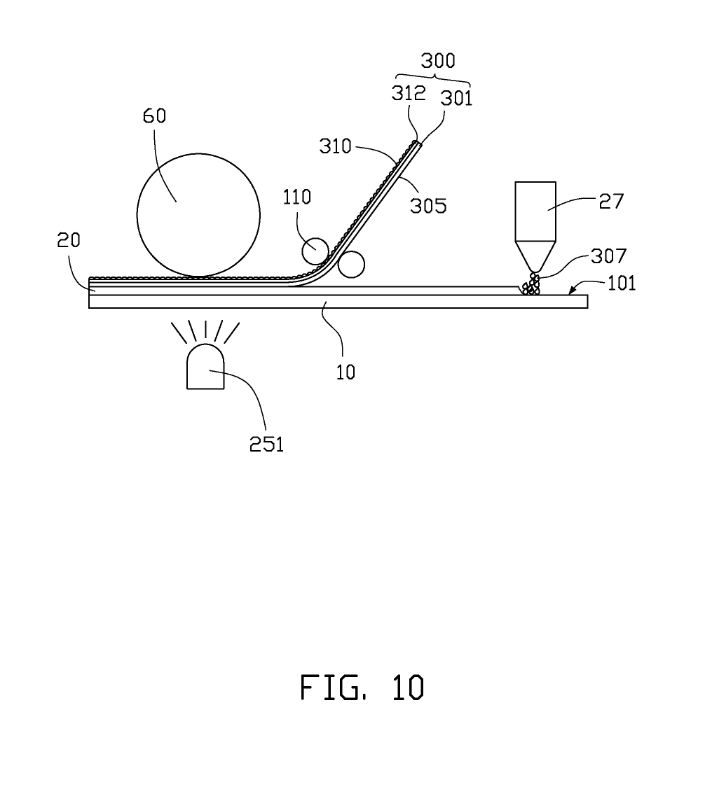

As shown in FIG. 10, a first transparent base layer 10 is provided. The first transparent base layer 10 includes a combined surface 101. A first glue 307 is coated on the combined surface 101.

As shown in FIG. 10, the transparent composite layer 30 is attached to the first transparent base layer 10.

As shown in FIG. 10, a pressing roller 60 and a plurality of pressure wheels 110 are provided, the pressing roller 60 is applied to press the transparent composite layer 30 to enable the transparent composite layer to be attached to the first transparent base layer 10. The pressure wheels 110 are configured for tightening the transparent composite layer 30 and preventing the transparent composite layer 30 from crimping. The first glue 307 is cured to form the adhesive layer 20, and the light guide plate 200 is obtained.

In summary, as mentioned above, first, the transparent composite layer is manufactured using PET or PC, because PET or PC has a lower cost; second, the transparent composite layer is attached with the first transparent base layer, because the first transparent base layer is made of PMMA, which has a steeper cost, and the large sized light guide plate is obtained, this will ensure the first transparent base layer will avoid being damaged, and yield of the light guide plate is improved.

The embodiments shown and described above are only examples. Many details are often found in the art such as other features of a protection system and protection method. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A light guide plate comprising:
a first transparent base layer and a transparent composite layer having a light emitting surface comprising a plurality of microstructures; and
an adhesive layer bonding the first transparent base layer to the transparent composite layer.

2. The light guide plate of claim 1, wherein a refractive index of the transparent composite layer is larger than a refractive index of the first transparent base layer.

3. The light guide plate of claim 2, wherein a refractive index of the adhesive layer is between a refractive index of the first transparent base layer and a refractive index of the transparent composite layer.

4. The light guide plate of claim 1, wherein the microstructures are V-shaped grooves.

5. The light guide plate of claim 1, wherein thicknesses of both the first transparent base layer and the transparent composite layer are less than 100 micron, a thickness of the adhesive layer is less than 50 micron.

6. The light guide plate of claim 1, wherein the transparent composite layer comprises a second transparent base layer and a microstructure layer located on the second transparent base layer, the microstructures are formed on the surface of the microstructure layer away from the second transparent base layer, a material of the second transparent base layer is the same as a material of the microstructure layer.

7. The light guide plate of claim 1, wherein the transparent composite layer comprises a second transparent base layer and a microstructure layer located on the second transparent base layer, a material of the second transparent base layer is different from a material of the microstructure layer.

8. The light guide plate of claim 6, wherein the first transparent base layer is polymethylmethacrylate.

9. The light guide plate of claim 6, wherein the transparent composite layer is made of polycarbonate or polyethylene terephthalate.

10. The light guide plate of claim 6, wherein the adhesive layer is made of UV glue.

11. A method for manufacturing a light guide plate, the method comprising:
providing a platform and a second transparent base layer, the platform comprises a heating device, arranging the second transparent base layer on the platform, the second transparent base layer comprises a first surface and a second surface away from the first surface, heating the second transparent base layer to enable the second transparent base layer to reach its molten state;
providing a mold die, the mold die is substantially cubic and comprises an pressing surface, the pressing surface has a plurality of microstructures, the mold die is configured for molding microstructures on the first surface of the second transparent base layer to obtain the transparent composite layer;
providing a first transparent base layer, the first transparent base layer comprising a combined surface, coating a first glue on the combined surface;
attaching the transparent composite layer to the first transparent base layer;
providing a pressing roller, applying the pressing roller to pressing the transparent composite layer to enable the transparent composite layer adhesive to the first transparent base layer; and
solidify the first glue to form the adhesive layer, and the light guide plate is finished.

12. The method of claim 11, wherein the roller is made of rubber or foam.

13. The method of claim 11, wherein a refractive index of the second transparent base layer is larger than a refractive index of the first transparent base layer.

14. The method of claim 11, wherein a refractive index of the adhesive layer is between a refractive index of the first transparent base layer and a refractive index of the second transparent base layer.

15. The method of claim 11, wherein the microstructures is V-shaped grooves.

16. A method for manufacturing a light guide plate, the method comprising:
providing a platform and a second transparent base layer, arranging the second transparent base layer on the platform, the second transparent base layer comprises a first surface and a second surface away from the first surface;
coating a second glue with molten state on the first surface;
providing a mold die, the mold die is substantially a cubic and comprises a pressing surface, the pressing surface has a plurality of microstructures, the mold die is configured for molding microstructures on the second glue, to obtain the transparent composite layer;
providing a first transparent base layer, the first transparent base layer comprising a combined surface, coating a first glue on the combined surface;
attaching the transparent composite layer to the first transparent base layer;
providing a pressing roller, pressing the transparent composite layer to enable the transparent composite layer adhesive to the first transparent base layer use the first glue; and
curing the first glue to form the adhesive layer, and the light guide plate is finished.

17. The method of claim 16, wherein the pressing roller is made of rubber or foam.

18. The method of claim 16, wherein a refractive index of the second transparent base layer is larger than a refractive index of the first transparent base layer.

19. The method of claim 16, wherein a refractive index of the adhesive layer is between a refractive index of the first transparent base layer and a refractive index of the second transparent base layer.

20. The method of claim 16, wherein the first glue and the second glue are UV glue.
